(19) United States
(12) Patent Application Publication
(10) Pub. No.: US 2009/0270670 A1
(43) Pub. Date: Oct. 29, 2009

(54) RECOVERY OF ORGANIC CONTAMINANTS FROM TERRESTRIAL ENVIRONMENTS

(76) Inventors: Andrew Daugulis, Kingston (CA); George Prpich, Saskatoon (CA); Lars Rehmann, Kingston (CA)

Correspondence Address: OGILVY RENAULT LLP, 1, Place Ville Marie, SUITE 2500, MONTREAL, QC, H3B 1R1, CA

(21) Appl. No.: 12/238,127

(22) Filed: Sep. 25, 2008

Related U.S. Application Data
(60) Provisional application No. 60/975,353, filed on Sep. 26, 2007.

(51) Int. Cl. B09C 1/00

(52) U.S. Cl. 588/249

(57) ABSTRACT

The present invention concerns a method for removing organic contaminants from a terrestrial environment, such as soil. The method involves contacting the contaminated soil with a solid polymeric material having an affinity for a target organic contaminant, without the need to add any liquid to the soil to form a slurry and/or without the need for the soil to have a high moisture content. Preferably, the organic contaminants absorbed into the polymer materials are removed from the polymer and the polymer reused.

### FIELD OF INVENTION

The present invention relates to a method of removing organic contaminants from soil using solid polymeric absorbents, without the need for any pre-treatment of the soil with a liquid such as water or an organic solvent. This method represents an uncomplicated, inexpensive, low energy, treatment for the remediation of soil contaminated with organic pollutants.

### BACKGROUND

Toxic organic contaminants have been shown to extensively affect both terrestrial and aqueous environments. The source and type of contamination varies greatly, however, there exists a shared consensus that organic contaminants are deleterious to biotic life and therefore must be removed. As a result of their hazardous potential, coupled with increasingly stringent environmental standards and guidelines, there is a necessity for the continued development of effective remediation technologies.

The successful implementation of a remediation technology is dependent on the ability of the technology to provide effective and economical removal of a target contaminant. Certain methods of remediating contaminated soils are well known in the art. Among the most common remediation strategies is excavation followed by incineration or storage at a regulated hazardous waste disposal site. Alternative treatment technologies may take a number of forms that may be carried out in situ or ex situ, and may be employed on or off site.

An example of an alternative technology for the remediation of soil affected with organic contaminants is soil washing. Traditional soil washing treatments require the addition of water, an organic solvent, or an aqueous solution containing a surfactant to the contaminated soil. The technique involves the transfer of the contaminant from the soil to the washing liquid, which is then recovered and treated separately. However, a number of disadvantages are associated with this technique including the requirement for large volumes of liquid to treat the soil, the generation of additional waste material, the cost of organic solvents, as well as the cost of equipment to transfer, mix and separate the solutions.

It is also known to use particulated rubber and biogeneric amorphous silica to immobilize hazardous wastes in soil. However, this process is reversible and is dependent on the maintenance of a thermodynamic equilibrium. As such, leaching of the contaminant could occur over time. Typically therefore, this does not remove the contaminants from the soil and does not result in remediation of the soil sample.

Polymers have also been applied in aqueous environments to absorb hydrocarbons, as result of an oil spill (International Patent Application Publication No. WO 90/14159).

Processes in which polymers remove organic contaminants from soil ex situ, in combination with soil washing, have also been described. In these processes, the polymer was used to enhance recovery of the organic contaminant. These systems require an additional liquid stream, the generation of a contaminated liquid waste stream, the requirement for organic solvents or other solubilizing agents, additional treatment steps including flotation of the polymer, and finally dewatering of the soil.

There remains a need to identify more efficient and cost-effective soil remediation technology. Simplified methods that reduce the number of steps required to remove the contaminant and eliminate the need to slurry the soil sample would be of particular benefit.

### SUMMARY OF INVENTION

In one aspect, there is provided a method of removing an organic contaminant from a soil sample, the method comprising selecting at least one solid polymer capable of effectively absorbing the organic contaminant; contacting the soil sample with the at least one solid polymer for a time effective to at least partially absorb the organic contaminant; and removing the at least one solid polymer from the soil sample; wherein the method does not involve the addition of a liquid to the soil sample to form a slurry.

a method of removing an organic contaminant from a soil sample through steps of selecting at least one solid polymer capable of effectively absorbing the organic contaminant; contacting the soil sample with the solid polymer for absorption of the organic contaminant by the solid polymer; and removing the organic contaminant-absorbed solid polymer from the soil sample. The method does not involve the addition of a liquid to the soil sample to form a slurry.

In a further aspect, there is provided a method of removing an organic contaminant from a soil sample, the method comprising selecting at least one solid polymer capable of effectively absorbing the organic contaminant; contacting the soil sample with the at least one solid polymer for a time effective to at least partially absorb the organic contaminant; and removing the at least one solid polymer from the soil sample, wherein the moisture content of the soil sample is less than 80%.

### BRIEF DESCRIPTION OF FIGURES

These and other features of the preferred embodiments of the invention will become more apparent in the following detailed description in which reference is made to the appended drawings wherein:

FIG. 1 shows phenol removal from soil using polyether-ester block copolymer (Hollow squares represent biotic control, solid square represent abiotic control, solid triangles represent polymer treatment).

FIG. 2 shows the release and biodegradation of phenol from polyether-ester copolymer beads. Solid squares represent phenol concentration in the aqueous phase; hollow circles represent increase in biomass.

### DETAILED DESCRIPTION

In the following description, numerous specific details are set forth to provide a thorough understanding of the invention. However, it is understood that the invention may be practiced without these specific details.

In one aspect, there is provided a method of removing an organic contaminant from a soil sample, the method comprising selecting at least one solid polymer capable of effectively absorbing the organic contaminant; contacting the soil sample with the at least one solid polymer for a time effective to at least partially absorb the organic contaminant; and removing the at least one solid polymer from the soil sample; wherein the method does not involve the addition of a liquid to the soil sample to form a slurry.

Slurrying is the addition of a liquid, such as water or an organic solvent, to solid particles resulting in a flowable mixture that upon sitting, results in separate liquid and solid phases. A slurry, as distinct from a solution, consists of two distinct phases (free liquid and particulate solid).

The method involves contacting a contaminated soil and a solid polymer, resulting in the preferential absorption of a target contaminant into the polymer matrix and reduction in the concentration of contaminant in the soil. Preferably, the soil sample and the solid polymer are mixed prior to removal of the solid polymer from the soil. The contaminant-absorbed polymer may then be separated from the soil, via sieving, screening, cyclones and/or centrifugation, for example. In some cases, the reduction in contaminant level achieved by this technique may be such that the soil can be considered to be largely contaminant-free and, hence, returned to the environment. The contaminant-absorbed polymer may be treated so as to remove or destroy the contaminant held within it, making it available for subsequent use.

Advantageously, removal of organic contaminants from a soil sample does not require the addition of water, surfactant or organic solvent (e.g. to form a slurry). Contaminated soil can be treated in its native, unaltered state by the methods of the present invention, providing simplified implementation, reduced volume of waste and lower energy inputs (no dewatering step) compared to other technologies. For example, there is no need to address an additional contaminated liquid stream.

In a further aspect, there is provided a method of removing an organic contaminant from a soil sample, the method comprising selecting at least one solid polymer capable of effectively absorbing the organic contaminant; contacting the soil sample with the at least one solid polymer for a time effective to at least partially absorb the organic contaminant; and removing the at least one solid polymer from the soil sample, wherein the moisture content of the soil sample is less than 80%.

In increasing preferability, the moisture content of the soil sample is less than 70%, 60%, 50%, 40%, 30%, 20%, 10% and 5%.

Preferably, solid polymers of use in the present invention are derived from organic material. In some circumstances, the solid polymer may consist of a specifically designed blend. Alternatively, the solid polymer may be derived from recyclable plastic waste. Solid polymers that may be employed include thermoplastic copolymer derivatives such as styrene butadiene including the styrene butadiene styrene copolymer (SBS), polyether-esters, polyurethanes, nylon, ethylene vinyl acetate, ethylene vinyl alcohol, as well as recyclable thermoplastics such as rubber automobile tires, low and high density polyethylene, and polyethylene terephthalate. Selection of the appropriate polymer will depend on the contaminant to be removed and would be understood by a person of ordinary skill in the art. Polymers may be selected based on physicochemical characteristics in common with the organic contaminant, such as polarity (Alpendurada (2000) J. Chromatography 889:3-14; Bruce and Daugulis (1991) Biotechnol. Prog. 7:116-124). The solid polymer is of a geometry to permit absorption of the organic contaminant. Preferable polymer shapes include a sphere, a cylinder, a pellet, a sheet and a rod.

In one embodiment, at least two solid polymers are used for the removal of the organic contaminant. Preferably, at least three solid polymers are used for the removal of the organic contaminant.

In some embodiments, the soil sample can be contacted with the solid polymer in a pile. Preferably, the contact occurs under any one of static or intermittently mixed conditions. Mechanical means can be used to achieve intermittent mixing.

The method can be used to treat a soil sample contaminated with hydrocarbons, as result of an oil spill, for example as part of the rapid spill response. Due to the independent nature of the process (i.e. no addition of liquid required), the presently disclosed methods may be quickly deployed to a spill site in an effort to absorb excess oil thus avoiding potential migration of oil below surface or to sources of water, both surface and aquifer.

Examples of organic contaminants removable from soil samples by the methods of the present invention include aromatic and long chain hydrocarbons and include those associated with the petroleum industry, such as diesel fuel, gasoline, jet fuel, heating oil and kerosene; an aromatic compound such as phenol and phenol derivatives including chlorophenol and nitrophenol; polycyclic aromatic hydrocarbons (PAHs) such as phenanthrene, fluoranthrene, pyrene, acenaphthene, acenaphthylene, anthracene, benz[a]anthracene, benzo[a]pyrene, benzo[e]pyrene, benzo[b]fluoranthene, benzo[g,h,i]perylene, benzo[j]fluoranthene, benzo[k]fluoranthene, chrysene, dibenz[a,h]anthracene, fluoranthene, fluorine, indeno[1,2,3-c,d]pyrene, phenanthrene, pyrene and mixtures of any of the above; polychlorinated hydrocarbons (PCBs); substituted hydrocarbon compounds; substituted aromatic compounds; nitroarene compounds; mixtures of any of the above, as well as other organic contaminants that may be of environmental concern.

In some embodiments, the methods described herein are used remove pharmaceutical compositions, such as antibiotics, hormones, flavonoids, terpenes and steroids, from soil samples.

Preferably, the contaminant-absorbed polymer is regenerated. Regeneration of contaminant-absorbed polymers has been described, using both physical and thermal techniques. The organic contaminant can be removed from the solid polymer by desorption into an aqueous environment or removal under ambient conditions. In one example, organic contaminant-absorbed polymers of the present invention may be regenerated using a two-phase partitioning bioreactor such as that described in U.S. Patent Application Publication No. 20040161842 or in Biotechnol. Prog. 20:1725-1723, Prpich and Daugulis, (2005) “Polymer development for enhance delivery of phenol in a solid-liquid two-phase partitioning bioreactor”.

Once in the bioreactor, the polymers release the absorbed contaminants in an aqueous environment, for consumption and subsequent destruction by bacteria. The polymer is regenerated under ambient conditions, avoiding more aggressive regeneration techniques. The regeneration of organic contaminant-absorbed polymers may also occur in a conventional municipal/commercial activated sludge process, well known to the person of skill in the art, used for the biodegradation of organic pollutants. Similar to regeneration of the polymers using the two-phase partitioning bioreactor, the activated sludge process results in the release of the organic contaminant from the polymer into the aqueous environment, resulting in mineralization of the contaminant by bacterial agents. Alternatively, the organic contaminant-absorbed polymers may be brought into contact with microbes in the native soil sample to effect contaminant removal and mineralization, and consequently polymer regeneration. The regenerated polymer absorbents can then be reused to remove additional contaminants from soil.

The advantages of the present invention are further illustrated by the following examples. The examples and their particular details set forth herein are presented for illustration only and should not be construed as a limitation on the claims of the present invention.

### Example 1

A sandy loam soil with a naturally-occurring moisture content of 35% was contaminated with 2500 mg phenol/kg soil. Soil moisture content was determined by drying soil in an oven at 80° C. for 48 h. Soil samples were weighed before and after drying with the difference in mass being accounted as loss of moisture. The mass lost divided by the total mass of the sample multiplied by 100% was the soil moisture. Moisture content was determined by adding a known mass of water to a known mass of dry soil. To confirm the moisture content, samples were dried in the oven as described herein. A person skilled in the art will also appreciate that varying types of soil will hold varying amounts of moisture. For example, soils that are sandy will hold less moisture than those that have high clay content. Two soils of differing composition with the same water content (i.e. 30% moisture) may therefore behave differently. One soil may have standing water; the other may absorb the entire volume of water.

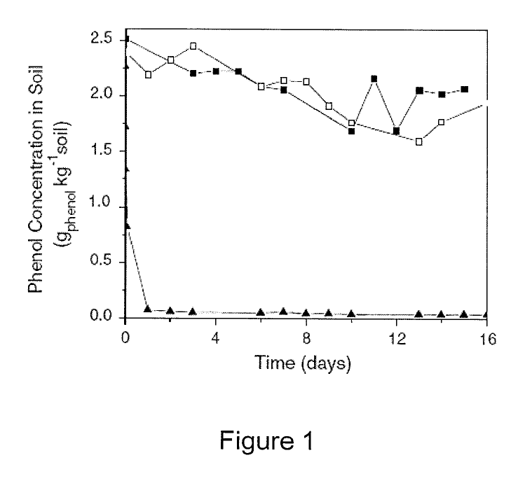

No additional water, organic solvents or solubilizing agents were added to the soil sample. The soil was contacted with a 10% mass fraction (w/w polymer to soil) of polyether-ester block copolymer, which took the form of small rice shaped pellets. The soil/polymer mixture was placed within a sealed glass vessel, which was then mixed manually, twice per 24 h period. An abiotic (Control 1) and biotic (Control 2) control were operated in parallel to determine the fate of phenol within soil systems without polymers being present. Upon completion of the experiment, the polymers were removed via sieving and analyzed for phenol content. The results of this experiment are shown in Table 1 and FIG. 1.

TABLE 1
Phenol removal from soil using polyether-ester block copolymer

| | Percent Phenol Removal (%) | | |
|---|---|---|---|
| Time (h) | Control 1 | Control 2 | Polymer Treated |
| 12 | — | — | 64 |
| 24 | — | — | 97 |
| 48 | 8 | 3 | 97 |

FIG. 1 shows phenol removal from soil using polyether-ester block copolymer (hollow squares represent biotic control, solid square represent abiotic control, solid triangles represent polymer treatment).
The results show that phenol was rapidly removed from the soil matrix and absorbed into the polymer pellets. Subsequent desorption of phenol from the polymer pellets accounted for nearly all of the phenol originally added to the soil (Table 2).

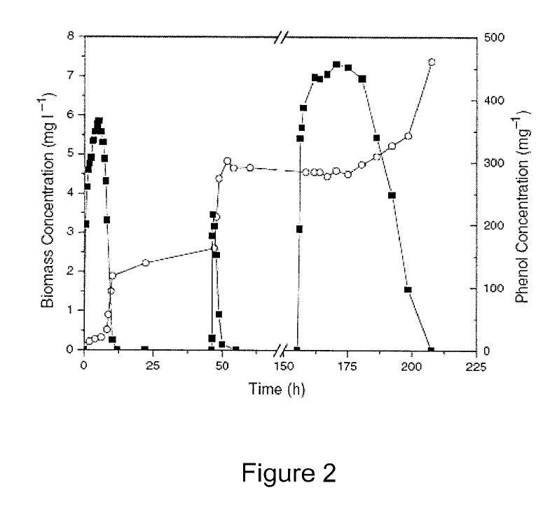

The polymer beads were regenerated in a two-phase partitioning bioreactor containing a microbial consortium capable of degrading phenol. The polymer beads were placed within a mineral salts solution as described previously (Prpich and Daugulis, “Enhanced Biodegradation of Phenol By a Microbial Consortium in a Solid-Liquid Two Phase Partitioning Bioreactor”, Biodegradation 16, 329-339, 2005) and the system was inoculated with the consortium. FIG. 2 describes the removal of phenol from the beads as well as the increase in biomass as result of phenol biodegradation.

Three replicate experiments were performed whereby phenol was absorbed from contaminated soil the beads were regenerated via biodegradation in a two-phase partitioning bioreactor and then reused. The results are given in Table 2. In addition, a mass balance was performed on the system to account for the phenol in both the soil and the polymer beads.

TABLE 2
Results of three removal and regeneration cycles

| | Initial | Final | | Biomass |
|---|---|---|---|---|
| | concentration | concentration | Mass of phenol | Yield |
| | of phenol in soil | of phenol in soil | in heads | g_{biomass} |
| Trial | mgₚₕₑₙₒₗ kg⁻¹ₛₒᵢₗ | mgₚₕₑₙₒₗ kg⁻¹ₛₒᵢₗ | mgₚₕₑₙₒₗ | g⁻¹ₚₕₑₙₒₗ |
| 1 | 2720 | 70 | 2286 | 0.98 |
| 2 | 2457 | 74 | 2484 | 1.27 |
| 3 | 2848 | 78 | 2797 | 1.21 |

The results indicate that the polymers do not lose capacity or performance over multiple regeneration steps and are capable of complete release of contaminant under ambient conditions.

### Example 2

Polycyclic aromatic hydrocarbons were removed from soil using polyurethane pellets. 10 g of standardized soil (10% organic, 20% clay, 70% sand) was contaminated with each of phenanthrene, fluoranthrene and pyrene to a concentration of 300 mg PAH/kg soil. The soil was contacted with a 10% w/w mass fraction of polyurethane pellets and sealed within a glass vial. Two treatment strategies were investigated for the removal of PAHs from soil. The first involved the use of dry soil, which had a moisture content of less than 5% and the second involved addition of 30% w/w distilled water. The vials were continually agitated for a 24 h period after which time the contents of the vials were analysed for the presence of PAHs and the polymers were desorbed in order to confirm the absorption of PAHs. The results of this experiment are shown in Table 3.

TABLE 3
Removal of polycyclic aromatic hydrocarbons (PAHs)
contaminants from soil using polyurethane pellets

Percent Removal of PAHs (%)

| Time (hours) | | Dry | Wet |
|---|---|---|---|
| 4 | Phenanthrene | 34 | 17 |
| | Fluorene | 15 | 10 |
| | Pyrene | 15 | 9 |
| 24 | Phenanthrene | 50 | 34 |
| | Fluorene | 42 | 25 |
| | Pyrene | 55 | 28 |

From the results, the use of the polymer absorbents under dry soil conditions removed approximately 50% of the PAHs while the addition of water removed 30%. The data demonstrate that the removal of PAHs using polymers under dry soil conditions in this experiment was more effective than processes using water slurry. The present methods obviate the need for the addition of water to slurry the soil, and do not result in the generation of a contaminated liquid waste.

### Example 3

Soil contaminated with petroleum hydrocarbons (e.g. diesel fuel) was remediated using recycled car tires. 30 g of standardized soil (described above) was contaminated with 2500 mg diesel/kg soil, contacted with 10% w/w mass fraction of recycled tire chips and sealed within a glass jar. Four treatment strategies were investigated to assess the removal of diesel contaminants from soil using recycled car tires. The first strategy investigated contaminant removal from dry soil, the second required slurrying the soil via addition of 60% w/w distilled water, the third required 60% w/w distilled water containing 2.5% v/v of a commercially available oil scrubbing surfactant and the fourth required addition of 60% w/w mixture containing equal parts water and organic solvent, isopropyl alcohol (IPA). At 60% w/w liquid, the soil formed a slurry while the dry soil was found to possess a moisture content of less than 5% w/w. The samples were agitated for a 24 h period after which time the soil was analysed for the presence of diesel. Results of this experiment are shown in Table 4.

TABLE 4
Removal of diesel from soil using recycled tire material

| Treatment | Percent Removal Diesel (%) |
|---|---|
| Dry soil | 90 |
| Water | 95 |
| Water and surfactant | 75 |
| Water and IPA | 95 |

From the results, it is clear that the removal of organic contaminants from dry soil can be achieved without the added complexity and expense of adding water or other solvents/agents, and with comparable contaminant removal results. Removing the requirement of a liquid to promote contaminant uptake by solid polymers, enabling treatment of contaminated soil samples in their “as-is” dry soil state, reduces the overall volume of waste produced and simplifies the remediation process. Additional economic and energy benefits are obtained as a result of obviating the need for the purchase, transport and disposal of liquid extractants.

Although preferred embodiments of the invention have been described herein, it will be understood by those skilled in the art that variations may be made thereto without departing from the spirit of the invention or the scope of the appended claims.

All documents referred to in the specification are herein incorporated by reference.

1. A method of removing an organic contaminant from a soil sample, the method comprising:
a) selecting at least one solid polymer capable of effectively absorbing the organic contaminant;
b) contacting the soil sample with the at least one solid polymer for a time effective to at least partially absorb the organic contaminant; and
c) removing the at least one solid polymer from the soil sample after step (b),
wherein the method does not involve the addition of a liquid to the soil sample to form a slurry.

2. The method of claim 1, wherein step (b) further comprises mixing the at least one solid polymer and the soil sample.

3. The method of claim 1, wherein step (c) comprises removing the at least one solid polymer via at least one of sieving, screening, cyclones and centrifugation.

4. The method of claim 1, wherein the moisture content of the soil sample is less than 80%.

5. The method of claim 1, wherein the moisture content of the soil sample is less than 70%.

6. The method of claim 1, wherein the moisture content of the soil sample is less than 60%.

7. The method of claim 1, wherein the moisture content of the soil sample is less than 40%.

8. The method of claim 1, wherein the moisture content of the soil sample is less than 30%.

9. The method of claim 1, wherein the moisture content of the soil sample is less than 20%.

10. The method of claim 1, wherein the moisture content of the soil sample is less than 10%.

11. The method of claim 1, wherein the moisture content of the soil sample is less than 5%.

12. The method of claim 1, wherein the at least one solid polymer is a geometry such as a sphere, cylinder, pellet, sheet or rod.

13. The method of claim 1, wherein the at least one solid polymer is selected from the group comprising: styrene butadiene styrene copolymer (SBS), a rubber tire material, a low or high density polyethylene, a polyethylene terephthalate, a thermoplastic, a polyether ester, an ethylene vinyl acetate, a styrene butadiene, a ethyl vinyl alcohol, a nylon, and a polyurethane.

14. The method of claim 13, wherein the rubber tire material, the low or high density polyethylene, and the polyethylene terephthalate are recycled material.

15. The method of claim 1, wherein the at least one solid polymers is at least two solid polymers.

16. The method of claim 1, wherein the at least one solid polymer is at least three solid polymers.

17. The method of claim 1, wherein the soil sample is contacted with the solid polymer in a pile under one of static or intermittently mixed conditions.

18. The method of claim 17, wherein the soil sample is contacted and intermittently mixed with the solid polymer using mechanical means.

19. The method of claim 1, wherein the organic contaminant is an organic compound selected from the group comprising a hydrocarbon, an aromatic compound, a polyaromatic compound, a nitroarene compound, a substituted hydrocarbon compound, a substituted aromatic compound and mixtures of any of the foregoing.

20. The method of claim 1, wherein the organic compound is selected from the group consisting of an unsubstituted hydrocarbon, a substituted hydrocarbon, a polychlorinated hydrocarbon (PCB), and a polycyclic aromatic hydrocarbon.

21. The method of claim 19 wherein the hydrocarbon is a petroleum-based hydrocarbon.

22. The method of claim 21, wherein the petroleum-based hydrocarbon is selected from the group consisting of diesel gasoline, jet fuel, heating oil, and kerosene.

23. The method of claim 20, wherein the organic contaminant is a polycyclic aromatic hydrocarbon selected from the group consisting of phenanthrene, fluoranthrene, pyrene and mixtures thereof.

24. The method of claim 20, wherein the polycyclic aromatic hydrocarbon is selected from the group consisting of acenaphthene, acenaphthylene, anthracene, benz[a]anthracene, benzo[a]pyrene, benzo[e]pyrene, benzo[b]fluoranthene, benzo[g,h,i]perylene, benzo[j]fluoranthene, benzo[k]fluoranthene, chrysene, dibenz[a,h]anthracene, fluoranthene, fluorine, indeno[1,2,3-c,d]pyrene, phenanthrene, pyrene and mixtures thereof.

25. The method of claim 19, whereby the organic contaminant is a substituted hydrocarbon.

26. The method of claim 19, wherein the aromatic compound is a phenol compound selected from the group consisting of a phenol and a phenol derivative.

27. The method of claim 26, wherein the phenol derivative is a substituted phenol selected from the group consisting of chlorophenols and nitrophenols.

28. The method of claim 1, wherein the organic contaminant is a pharmaceutical composition selected from the group consisting of antibiotics, hormones, flavonoids, terpenes and steroids.

29. The method of claim 1 further comprising the step of releasing the organic contaminant from the solid polymer.

30. The method of claim 29, wherein the organic contaminant is released from the solid polymer through desorption into an aqueous environment.

31. The method of claim 29, wherein the organic contaminant is released from the solid polymer under ambient conditions.

32. The method of claim 1, wherein following the release of the organic contaminant, the solid polymer is reused in the method of claim 1.

33. The method of claim 1, further comprising the step of mineralizing the organic contaminant absorbed within the solid polymer by bacteria contained within a bioreactor, in an activated sludge system, or in the contaminated soil sample.

34. The method of claim 33, wherein the bacteria is one of endogenous to the contaminated soil sample and added exogenously to the contaminated soil sample.

35. The method of claim 1, wherein the organic contaminant contained within the solid polymer is incinerated.

36. A method of removing an organic contaminant from a soil sample, the method comprising:
a) selecting at least one solid polymer capable of effectively absorbing the organic contaminant;
b) contacting the soil sample with the at least one solid polymer for a time effective to at least partially absorb the organic contaminant; and
c) removing the at least one solid polymer from the soil sample after step (b),
wherein the moisture content of the soil sample is less than 80%.

37. The method of claim 36, wherein the moisture content of the soil sample is less than 70%.

38. The method of claim 37, wherein the moisture content of the soil sample is less than 60%.

39. The method of claim 38, wherein the moisture content of the soil sample is less than 40%.

40. The method of claim 39, wherein the moisture content of the soil sample is less than 30%.

41. The method of claim 40, wherein the moisture content of the soil sample is less than 20%.

42. The method of claim 41, wherein the moisture content of the soil sample is less than 10%.

43. The method of claim 42, wherein the moisture content of the soil sample is less than 5%.
